(19) United States
(12) Patent Application Publication
(10) Pub. No.: US 2025/0299061 A1
(43) Pub. Date: Sep. 25, 2025

(54) MULTI-MODALITY REINFORCEMENT LEARNING IN LOGIC-RICH SCENE GENERATION

(71) Applicant: Intel Corporation, Santa Clara, CA (US)

(72) Inventors: Peixi Xiong, Hillsboro, OR (US); Nilesh Jain, Portland, OR (US)

(73) Assignee: Intel Corporation, Santa Clara, CA (US)

(21) Appl. No.: 19/229,127

(22) Filed: Jun. 5, 2025

(51) Int. Cl. G06N 3/092; G06N 3/0475

(52) U.S. Cl. CPC G06N 3/092; G06N 3/0475

(57) ABSTRACT

Generating high-quality images of logic-rich three-dimensional (3D) scenes from natural language text prompts is challenging, because the task involves complex reasoning and spatial understanding. A reinforcement learning framework utilizing a ground truth data set can be implemented to train a policy network. The policy network can learn optimal parameters to refine a text prompt to obtain a modified text prompt. The modified text prompt can be used to obtain a three-dimensional scene, and the three-dimensional scene can be rendered and projected to obtain a rendered image. The framework involves an action agent for text modification, a generation agent to produce rendered images, and a reward agent to evaluate the rendered images. The loss function used in training the policy network optimizes visual accuracy and quality of the rendered images and semantic alignment between the rendered images and the text prompt.

### BACKGROUND

Generating 3D scenes from natural language prompts encompasses the use of artificial intelligence and computer graphics to create three-dimensional (3D) environments based on textual descriptions. Scene generation technology has the potential to revolutionize various industries by enabling the creation of immersive and interactive 3D models. Potential applications include virtual reality experiences, gaming, architectural visualization, educational tools, and simulation environments. By transforming written language into detailed 3D scenes, scene generation technology can enhance user engagement, provide innovative solutions for design and planning, and offer new ways to experience and interact with digital content.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a system to generate an image based on a text prompt, according to some embodiments of the disclosure.

FIG. 2 illustrates a system having one or more agents and methodology to train a policy network, according to some embodiments of the disclosure.

FIG. 3 illustrates an exemplary implementation of an action agent, according to some embodiments of the disclosure.

FIG. 4 illustrates an exemplary implementation of a generation agent, according to some embodiments of the disclosure.

FIG. 5 is a flowchart illustrating a method for training a policy network, according to some embodiments of the disclosure.

FIG. 6 illustrates an algorithm for training a policy network, according to some embodiments of the disclosure.

FIG. 7 is a flowchart illustrating a method for training a policy network, according to some embodiments of the disclosure.

FIG. 8 is a block diagram of an exemplary computing device, according to some embodiments of the disclosure.

### DETAILED DESCRIPTION

### Overview

Generating high-quality images of logic-rich three-dimensional (3D) scenes from natural language text prompts is challenging, because the task involves complex reasoning and spatial understanding. An example of a challenging text prompt is as follows: “Add a blue sphere at the center. Add a gray sphere in front of it on the left. Add another gray sphere behind it on the right and behind blue sphere on the right. Add a brown cylinder behind and on the right of the gray sphere which is in front of blue sphere on the left. Add a brown cube behind it on the right and behind blue sphere on the right.” Generating 3D scenes from natural language descriptions can enable machines to interpret and represent the real world through human language. The ability to create detailed, contextually rich 3D environments from text has numerous applications, including virtual reality, gaming, and design.

Some methods, while successful in generating two-dimensional images (2D) from text, often fall short when tasked with understanding the complex logic and nuanced relationships embedded in natural language. These methods, when extended to generating images of a 3D scene from text, struggle to comprehend and maintain detailed object positioning, spatial arrangements, and relational logic described in natural language. This limitation arises from the challenges in capturing the multi-layered dependencies within linguistic descriptions. Another method attempts to address this limitation by using scene graph generation to first extract relational data from text. However, the method relies on predefined templates or structures, which can limit their flexibility in interpreting more nuanced or complex spatial descriptions embedded in free-form text.

To address this technical problem, a policy network is introduced in a system for generating an image based on an input text prompt. The policy network can modify an input text prompt in a way to better capture complex interactions and contextual nuances. More specifically, the policy network can be trained through reinforcement learning using multimodality-based feedback. The policy network, once trained to reach a certain level of performance, can enable better alignment between generated/rendered images of 3D scenes and the intended meaning of the text. The policy network can learn optimal parameters to refine an input text prompt to obtain a modified text prompt. The modified text prompt can be used to obtain a three-dimensional scene, and the three-dimensional scene can be rendered and projected to obtain a rendered image.

The policy network can include a neural network. In one example, the neural network may include interconnected nodes, or neurons, organized in layers, such as an input layer, one or more hidden layers, and an output layer. Each neuron processes data and passes the result to the next layer. One or more parameters that impact the processing behavior of a neuron can be trained or updated to perform a certain task.

A reinforcement learning framework can be implemented to train the policy network, where the environment is defined as the interaction loop involving the input text prompt, the policy network, and the ground truth data used to compute rewards. The policy network can be trained by sampling from the ground truth data and updating the parameters of the policy network in an iterative, feedback-driven process. In some implementations, the reinforcement learning framework implements an iterative text modification process (referred to as playing an episode), where the input text prompt is refined successively by the policy network based on reward feedback until a condition is met to end the process, ensuring that each successive modification improves the quality and accuracy of the rendered image of the generated scene.

The reinforcement learning framework involves one or more agents, such as an action agent, a generation agent, and a reward agent.

An action agent can be implemented for text modification. More specifically, during training, the action agent may modify/refine the input text prompt iteratively, progressively, or successively based on feedback, such as feedback from the reward agent. In some implementations, the action agent includes an encoder to obtain one or more token-level embeddings representing the input text prompt. Herein, an embedding refers to numerical representations (e.g., a vector of values) of a token, such as a word or subword in the input text prompt. An encoder, e.g., such as a transformer-based neural network, can generate embeddings representing the input text prompt by processing the input text prompt through the neural network layers, capturing contextual information from different directions. The embedding can encapsulate semantic meaning and syntactic properties of the token (e.g., word or subword). The action agent includes the policy network, which can take the one or more embeddings representing the input text prompt and obtain a modified text prompt.

A generation agent can be implemented to produce rendered images. More specifically, the generation agent can convert the modified text prompt into 3D scene data. The 3D scene includes information for one or more objects, such as position coordinates and properties/attributes. The generation agent can render and project the 3D scene data from a particular viewing direction to obtain a rendered image of the 3D scene.

A reward agent can be implemented to evaluate the rendered image. According to one aspect, the reward agent can compute the reward based on the rendered image and the ground truth image corresponding to the input text prompt. More specifically, the reward agent can evaluate the rendered image based on one or more accuracy/quality metrics or reward components, such as object presence reward component, visual quality reward component, and diversity reward component. The reward agent can compute a reward based on a weighted sum of one or more reward components. The reward can guide the policy network in the action agent to improve text prompt modification/refinement, ensuring iterative improvement in the generated images during the episode. According to a further aspect, the reward agent can compute a loss, using a loss function, based on the reward and the one or more embeddings. The loss function used in training the policy network optimizes visual accuracy and quality of the rendered images and semantic alignment between the rendered images and the text prompt. One or more parameters of the policy network can be updated based on the loss.

Implementing the system involving the policy network trained in the manner described can greatly enhance image generation for 3D scenes from natural language descriptions and offer more accurate and semantically aligned output images. The policy network addresses the challenges of subject-object relationships and spatial reasoning by modifying the input text prompt in a way that yields more accurate object placement and scene integrity results. The resulting image generation system having the policy network can have applications in areas like virtual reality, autonomous systems, artificial intelligence driven design, automated content creation, and interactive environment generation.

In some experiments using structurally complex image data sets, the described techniques produced results that achieved the best overall performance according to metrics such as object presence matches and object position relation matches. The techniques described were able to achieve significant improvements over other solutions, particularly in terms of object presence and overall scene coherence.

### System to Generate an Image Based on a Text Prompt

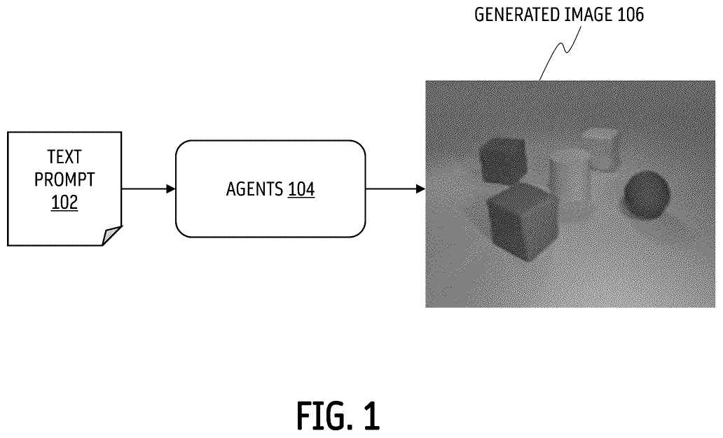

FIG. 1 illustrates a system to generate an image based on a text prompt, according to some embodiments of the disclosure. The system may include one or more agents 104. One or more agents 104 may include an action agent and a generation agent. One or more agents 104 may receive text prompt 102. Text prompt 102 may include a natural language description of a 3D scene. One example of text prompt 102 can include:

Add a yellow cylinder at the center. Add a blue cube behind
it on the left. Add a purple sphere in front of it on the right
and in front of yellow cylinder on the right and in front of
yellow cube on the right. The yellow cube is behind blue
cube on the right and behind yellow cylinder on the right.
Add a gray cube in front of it on the left and in front of
purple sphere on the left and in front of blue cube on the
right and in front of yellow cylinder on the left.

One or more agents 104 may generate generated image 106 based on text prompt 102.

Generated image 106 may be a rendered scene from a specified viewing pose/direction or an arbitrary viewing pose/direction. In some cases, one or more agents 104 may generate a 3D scene from which generated image 106 can be rendered, based on a specified viewing pose/direction or an arbitrary viewing pose/direction. In some cases, the 3D scene may change over time or have a temporal dimension, and generated image 106 may be a frame of a video capturing the 3D scene.

The technical task of one or more agents 104 is to produce generated images such as generated image 106 based on text prompts such as text prompt 102 in a manner that is accurate, even when the text prompt describes a logic-rich 3D scene. To perform the technical task, a reinforcement learning framework is implemented to train a policy network that can be implemented as part of one or more agents 104.

Herein, reinforcement learning is used to iteratively refine/modify the input text prompt to optimize the generated image based on a reward signal. The successive/progressive refinements are performed over an episode. The policy network, or the policy, denoted as π_{θ}, can be parameterized by θ. At a given time step t, the policy network can produce a modified input Pₜ based on a previous input Pₜ₋₁ and the reward signal Rₜ₋₁ received from an environment:

$${P}_{t} = {π}_{θ} ( {P}_{t - 1} , {R}_{t - 1} ) \qquad ( eq . 1 )$$

The objective is to maximize the expected cumulative reward, defined as:

$$( θ ) = [ {\sum }_{t = 0}^{T} {γ}^{t} {R}_{t} ] \qquad ( eq . 2 )$$

γ is a discount factor. Rₜ is a reward at time step t. T is the length of an episode. The policy π_{θ} can be updated using the gradient of the expected cumulative reward with respect to the policy parameters θ. The gradient can be given by the policy gradient theorem:

$${∇}_{θ} ( θ ) = [ {∇}_{θ} log {π}_{θ} ( {P}_{t} \vert {P}_{t - 1} ) {R}_{t - 1} ] \qquad ( eq . 3 )$$

The gradient can be used to adjust the parameters θ in the direction that maximize the expected reward to enable the policy network to refine the prompt and improve the prompt over time in the episode.

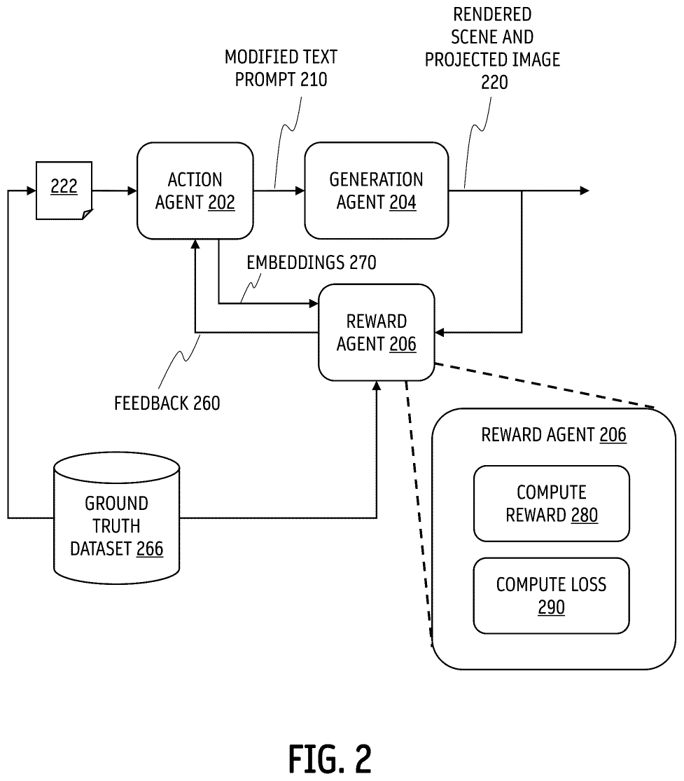

FIG. 2 illustrates a system having one or more agents and methodology to train a policy network, according to some embodiments of the disclosure. The system includes action agent 202, generation agent 204, and reward agent 206. The policy network can be implemented in action agent 202. Once trained to meet a certain performance criterion or a certain number of episodes have been played, action agent 202 and generation agent 204 can be implemented in one or more agents 104 of FIG. 1 to produce generated images based on input text prompts.

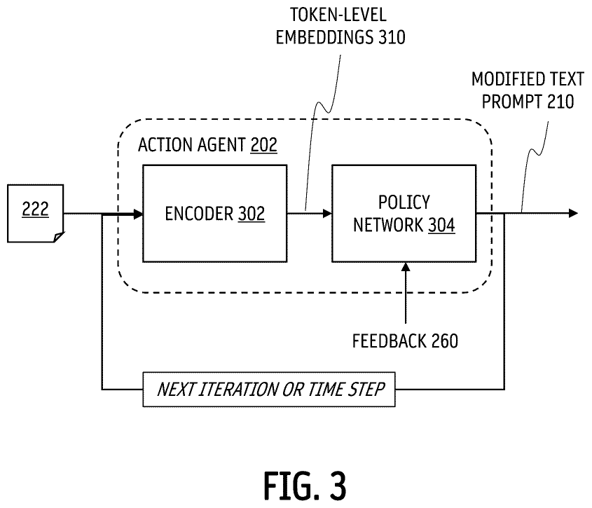

At a time step t during an episode, text prompt 222 can be provided as input to action agent 202. Action agent 202 generates modified text prompt 210 based on text prompt 222. A modified text prompt at time t is denoted as T^{t}. Modified text prompt 210 is provided as input to generation agent 204. Generation agent 204 transforms modified text prompt 210 into a rendered scene and projected image 220. A rendered scene at time t is denoted as S^{t}. A projected image of the rendered scene at time t is denoted as I^{t}. The projected image is a 2D projection of the S^{t} from a predetermined or fixed viewing pose/direction, to allow for more consistent evaluation of the output produced by generation agent 204 across time steps and episodes. Generation agent 204 can bridge the gap between the input natural language descriptions and the desired visual output capturing a 3D scene. FIGS. 3-7 illustrate additional details about action agent 202 and generation agent 204.

Rendered scene and projected image 220 are provided as input to reward agent 206. One or more of the rendered scene and projected image 220 can be used to evaluate the result and calculate a reward signal Rₜ. Reward agent 206, e.g., compute reward 280, can compute a reward Rₜ by evaluating the accuracy/quality of the output produced by generation agent 204, based on information ground truth data set 180. The reward can be used as part of feedback 260 to guide or inform the update of the policy network in action agent 202. Reward agent 206, e.g., compute loss 290, can compute a loss based on the reward. The design of reward agent 206 ensures that the reinforcement learning process is aligned with the objective of generating semantically accurate and visually high-quality images of 3D scenes.

Reward agent 206 can include compute reward 280. Compute reward 280 can compute a reward based on one or more of: the rendered scene S^{t}, the projected image I^{t}, and a ground truth image corresponding to text prompt 222. The ground truth image can be denoted as I_{reference}, and can be obtained from ground truth dataset 266. The reward signal Rₜ effectively evaluates the quality of the rendered scene and/or the projected image and informs whether an action performed by the policy network (e.g., selecting the modification that resulted in the produced modified text prompt 210) led to an improvement in the visual output of generation agent 204.

A reinforcement learning framework can be implemented to train the policy network in action agent 202. In the framework, the environment is defined as the interaction loop involving text prompt 222, the policy network in action agent 202, and ground truth dataset 266. In particular, reward agent 206 may use ground truth dataset 266 to compute rewards. Reward agent 206 can evaluate the output(s) produced by generation agent 204 based on the environment and compute a reward. The reward can be used as part of the feedback 260 to the action agent 202. Ground truth dataset 266 may include 2D images of 3D scenes and text descriptions corresponding to the 2D images. Ground truth dataset 266 can include a number of pairs of a 2D image and text description of the 2D image. The text descriptions may be produced by human annotators. In some cases, the text descriptions may be produced by a machine learning model that can produce a text description of an input image.

In some embodiments, compute reward 280 computes a reward based on a weighted sum of one or more reward components. As discussed previously, at a time step t during an episode, reward agent 206 calculates a reward signal Rₜ based on one or more of the rendered scene S^{t}, a projected image I^{t} from generation agent 204, and a ground truth image I_{reference}. The reward components are defined and chosen to provide meaningful feedback to drive the policy network in action agent 202 towards the goal of generating more accurate images and diverse 3D scenes. The reward components can include one or more of: an object presence reward component R_{object}^{t}, a visual quality reward component Rₜ quality, and a diversity reward component Rₜ diversity. At a time step t during an episode, the reward signal Rₜ can be expressed as a weighted sum of the individual reward components as follows:

$${R}_{t} = α \cdot {R}_{o b ject}^{t} + β \cdot {R}_{q u ality}^{t} + γ \cdot {R}_{diversity}^{t} \qquad ( eq . 4 )$$

α, β, γ are weights that balance the contribution of the corresponding reward component. The weights are set to ensure that the reinforcement learning framework optimizes for object accuracy, visual quality, and diversity effectively and simultaneously.

Object presence reward component R_{object}^{t} evaluates the accuracy of objects present in the rendered scene S^{t} and/or the projected image I^{t}. Object presence reward component R_{object}^{t} can quantify whether the objects described in the text prompt 222 or present in the ground truth image I_{reference}, are correctly represented in the rendered scene S^{t} and/or the projected image I^{t}. To calculate object presence reward component R_{object}^{t} compute reward 280 can apply an object detection algorithm on text prompt 222 and/or the ground truth image I_{reference} to determine a list of one or more expected objects present and one or more characteristics/attributes for each expected object. The characteristics/attributes can include size, position coordinates, orientation/pose, color, texture, spatial arrangement, spatial relationship, etc. In some implementations, the list of expected objects and corresponding characteristics/attributes of the expected objects are part of ground truth dataset 266. To calculate object presence reward component R_{object}^{t}, compute reward 280 can apply an object detection algorithm on the rendered scene S^{t} and/or the projected image I^{t}, and obtain a list of one or more objects present in the rendered scene S^{t} and/or the projected image I^{t} and one or more characteristics/attributes for each object present in the rendered scene S^{t} and/or the projected image I^{t}. The characteristics/attributes can include size, position coordinates, orientation/pose, color, texture, spatial arrangement, spatial relationship, etc. If an expected object o, described in the text prompt, or extracted from a ground truth image I_{reference}, is present in the rendered scene S^{t} and/or the projected image I^{t}, then the object presence reward component R_{object} is increased, otherwise, the object presence reward component Rₜ object is decreased to penalize for a missing object. The positive contribution of the expected object o to the object presence reward component R_{object}^{t} can be weighted by the extent that one or more attributes/characteristics of the object present in the rendered scene S^{t} and/or the projected image I^{t} matches one or more expected attributes/characteristics of the expected object o, described in the text prompt, or extracted from a ground truth image I_{reference}. In some embodiments, compute reward 280 computes an object presence reward component R^{t}_{object} based on one or more of: whether an expected object o is present in the rendered scene S^{t} and/or the projected image I^{t}, and whether an attribute of an object present in the rendered scene S^{t} and/or the projected image I^{t} matches an expected attribute of the expected object o. The object presence reward component R_{object}^{t} can be formulated as follows:

$${R}_{o b ject}^{t} = {\sum }_{i = 1}^{n} ( {o}_{i} ∈ detected ) \cdot match ( {o}_{i} , attributes ) \qquad ( eq . 5 )$$

[symbol] (oᵢ∈ detected) is an indicator function that is equal to 1 if the expected object oᵢ is detected in the rendered scene S^{t} and/or the projected image I^{t}, and 0 otherwise. match (oᵢ, attributes) is a function that measures how well the expected attributes match the attributes of the object present in the rendered scene S^{t} and/or the projected image I^{t}. match (oᵢ, attributes) can output a percentage or fraction representing the match. match (oᵢ, attributes) can output a score or a normalized score that correlates positively with the extent of the match. The sum can run over all expected objects i.

Visual quality reward component Rₜ quality measures the visual quality of the generated output from generation agent 204, e.g., the rendered scene S^{t} and/or the projected image I^{t}, with respect to a reference image, e.g., ground truth image I_{reference}. To capture fidelity of the generated output, in terms of visual appearance and structure, the visual quality reward component Rₜ quality can utilize perceptual quality metrics, such as Structural Similarity Index (SSIM) and the Fréchet Inception distance (FID) to evaluate the quality of the generated output. The SSIM score may be referred to as a similarity score. The FID score may be referred to as a distance score. The visual quality reward component Rquality can include a weighted sum of the similarity score and the distance score. In some embodiments, compute reward 280 computes a visual quality reward component Rₜ quality based on one or more of: a similarity score between the rendered scene S^{t} and/or the projected image I^{t} and the ground truth image I_{reference}, and a distance score between the rendered scene S^{t} and/or the projected image I^{t} and the ground truth image I_{reference}. The visual quality reward component Rquality can be formulated as follows:

$${R}_{quality}^{t} = SSIM ( {I}^{t} , {I}_{reference} ) - λ \cdot FID ( {I}^{t} , {I}_{reference} ) \qquad ( eq . 6 )$$

SSIM (It, l_{reference) measures the perceptual similarity between the projected image I}^{t} and the ground truth image I_{reference}. FID (It, l_{reference) measures or quantifies the distance between the distributions of the projected image I}^{t} and the ground truth image I_{reference} in a feature space. The hyperparameter λ balances the contribution of SSIM score and FID score to the overall visual quality reward component R_{quality}^{t}. Giving more weight to SSIM score and lower weight to FID score can encourage the reinforcement learning system to generate visually appealing and accurate scenes.

The hyperparameter λ can be set to 0.3, slightly favoring perceptual similarity.

Diversity reward component R_{diversity}^{t} is designed to encourage diversity across different generated outputs (e.g., the rendered scenes S^{t} and/or the projected images I^{t}) at different time steps t of an episode. Diversity reward component R_{diversity}^{t} can be used to prevent action agent 202 and generation agent 204 from generating repetitive or overly similar outputs when given slightly different input text prompts during the episode. Diversity reward component R_{diversity}^{t} can be computed by comparing latent representations of different rendered scenes (e.g., S^{t} and S^{t-1}) and/or projected images (e.g., I^{t} and I^{t-1}) generated from similar input text prompts. By encouraging diversity, the reinforcement learning system can explore a wider space of possible scene configurations, which can lead to more creative and varied generated outputs. Latent representations of different rendered scenes (e.g., S^{t} and s^{t-1}) and/or projected images (e.g., I^{t} and I^{t-1}) can be obtained by inputting different rendered scenes (e.g., S^{t} and S^{t-1}) and/or projected images (e.g., I^{t} and I^{t-1}) into an encoder or feature extraction model. The comparison of the latent representations can be performed using a contrastive loss approach. In some embodiments, compute reward 280 computes a diversity reward component R_{diversity} that is a contrastive loss score between a rendered scene S^{t} or a projected image I^{t} and a further rendered scene S^{t-1} or a projected image I^{t-1} generated based on a further text prompt (e.g., a previous text prompt of the episode at a previous time step). Given rendered scenes S^{t} and S^{t-1} produced from two similar input text prompts, the diversity reward component R_{diversity} can be formulated as follows:

$${R}_{d iversity}^{t} = 1 - \frac{{‖ E ( {S}^{t} ) - E ( {S}^{t - 1} ) ‖}^{2}}{max ( {‖ E ( {S}^{t} ) ‖}^{2} , {‖ E ( {S}^{t - 1} ) ‖}^{2} )} \qquad ( eq . 7 )$$

E (s^{t}) represents the latent representation of the rendered scene S^{t}. E (S^{t-1}) represents the latent representation of the rendered scene S^{t-1}. The diversity reward component R_{diversity}^{t} penalizes generation of similar rendered scenes, thereby pushing the reinforcement learning framework to produce diverse outputs while maintaining accuracy and quality. A high diversity reward component R_{diversity}^{t} can indicate that the reinforcement learning system has generated visually distinct rendered scenes in response to similar but slightly varied input text prompts.

Reward agent 206 can calculate a reward signal Rₜ to guide the overall learning process by providing feedback that evaluates the quality of the generated output based on metrics such as object presence, visual quality, and diversity. The reinforcement learning system can optimize for multiple metrics simultaneously, which leads to better overall performance. The weights α, β, γ can be tuned to adjust the relative importance of each reward component, ensuring flexibility and adaptability to different tasks and datasets. The reward signal Rₜ can be employed as part of feedback 260.

The weight α can be set as 0.4 to ensure emphasis on object accuracy. The weight β can be set at 0.5 to prioritize high visual fidelity. The weight γ may be set as 1-α-β, or 0.1.

Reward agent 206 can include compute loss 290. Compute loss 290 can compute a loss based on the reward and one or more embeddings 270 produced by action agent 202. The loss can be denoted as [symbol] ₜₒₜₐₗ, and can be calculated based on a loss function. Reward agent 206 can update one or more parameters of the policy network in action agent 202 based on the loss calculated by compute loss 290. The loss can be used in feedback 260 to guide or inform the update of the policy network in action agent 202.

Compute loss 290 can compute the loss [symbol] ₜₒₜₐₗ based on a weighted sum of one or more loss components. The one or more loss components can include reinforcement learning loss [symbol] _{RL} based on the reward. The reinforcement learning loss [symbol] _{RL} can drive the improvement of scene generation by the system. The one or more loss components can include a semantic loss [symbol] _{semantic} based on the one or more embeddings representing the input text prompt and one or more further embeddings representing the modified text prompt. The semantic loss [symbol] _{semantic} can ensure that the modified text prompt retains the original meaning of the original input text prompt. The total loss function [symbol] ₜₒₜₐₗ can be a weighted combination of the reinforcement learning loss [symbol] _{RL} and the semantic loss [symbol] _{semantic}, and can be formulated as follows:

$${ℒ}_{total} = {ℒ}_{R L} + {λ}_{s e mantic} \cdot {ℒ}_{semantic} \qquad ( eq . 8 )$$

λ_{semantic} can be a hyperparameter that balances/controls the importance of maintaining semantic consistency. One exemplary value for λ_{semantic} is 1, to ensure that the reinforcement learning framework optimizes both the reward of producing a high-quality output and semantic alignment simultaneously and in a balanced manner during training.

The training process aims to optimize the policy network by maximizing the expected cumulative reward over the episode, as previously illustrated in equation 2. The discount factor γ of equation 2 can be set to 0.99 to balance short-term and long-term rewards (e.g., a value of 0.99 promotes long-term improvements). The one or more parameters θ of policy network can be updated to maximize the expected cumulative reward, with the gradient of the objective function according to equation 3 (e.g., ∇_{θ} [symbol] (θ)= [symbol] [∇_{θ}log π_{θ}(T^{t}|T^{t-1}) Rₜ]) to guide the refinement of text prompts for improved scene generation. In some implementations, [symbol] _{RL} is set based on the expected cumulative reward according to equation 2 and the gradient of the objective function according to equation 3.

The training process also aims to maintain semantic consistency, meaning that the modified text prompts should retain their original meaning. The semantic consistency loss [symbol] _{semantic} encourages the modified text prompt T^{t} to remain semantically similar to the original text prompt T⁰. The semantic loss [symbol] _{semantic} can be formulated as follows:

$${ℒ}_{semantic} = 1 - cos sim ( {f}^{t} , {f}^{0} ) \qquad ( eq . 9 )$$

f^{t} are the one or more embeddings representing the modified text prompt T^{t}, which can be obtained by inputting the modified text prompt T^{t} into an encoder. f⁰ are the one or more embeddings representing the original text prompt T⁰, which can be obtained by inputting the original text prompt T⁰ into an encoder. cos sim (f^{t}, f⁰) represents the cosine similarity score of f^{t} and f⁰. The semantic loss [symbol] _{semantic} can ensure that the modified text prompts do not diverge too far from the original semantic meaning of the original input text.

The total loss [symbol] ^{total} can be used to update one or more parameters θ of the policy network, and the update algorithm can be formulated as follows:

$$θ ← θ - η \cdot {∇}_{θ} {ℒ}_{total}$$

η is the learning rate of the policy network. In one example, η has a value of 0.001, and Adam optimizer (e.g., implementing Adaptive Moment Estimation) is used to ensure stable convergence during training.

Referring back to action agent 202, during an episode of training, action agent 202 iteratively modifies the text prompt based on feedback 260 from previous time steps of the episode. Given the encoded representation f^{t-1} from the previous time step, action agent 202 can generate a new modified text prompt T^{t}. Generating the modified text prompt T^{t} is controlled by the policy network π_{θ} of action agent 202, which is parameterizable by one or more parameters θ. More specifically, the policy network π_{θ} generates the modified text prompt T^{t} based on the current encoded prompt f^{t-1} and feedback 260 having the reward signal Rₜ₋₁ from the previous time step. The output of the policy network at time t is the new modified text prompt T^{t}, and can be represented as follows:

$${T}^{t} = {π}_{θ} ( {f}^{t - 1} , {R}_{t - 1} ) \qquad ( eq . 10 )$$

One or more parameters θ are updated iteratively to improve the system's ability to refine the text prompts. The output of action agent 202 is thus a modified version of the input text prompt, maintaining the same natural language format, but optimized to produce a better 3D scene.

The initial text prompt T⁰ used as text prompt 222 in an episode can be randomly sampled from ground truth dataset 266. The subsequent text prompts T¹, T², . . . . T^{T} used as text prompt 222 can be the modified text prompts generated by action agent 202 at various time steps. The initial text prompt T⁰ can be considered a cold start because it does not have a reward signal. At the start of an episode, the one or more embeddings of the initial text prompt f⁰ is used directly as input to the policy network Tte without any feedback signal, and the modified text prompt T¹ is generated based on the one or more embeddings of the initial text prompt f⁰:

$${T}^{1} = {π}_{θ} ( {f}^{0} ) \qquad ( eq . 11 )$$

The process thus can handle the cold start situation and initialize the episode without needing any prior knowledge of the reward, while allowing for subsequent time steps of the episode to be guided by the reward signal of the previous time step(s).

### Implementing the Action Agent

FIG. 3 illustrates an exemplary implementation of an action agent, such as action agent 202, according to some embodiments of the disclosure. Action agent 202 can include encoder 302, and policy network 304. As discussed with FIG. 2, the input of action agent 202 is text prompt 222, and the output of action agent 202 is modified text prompt 210. Action agent 202 can modify the text prompt iteratively, with the goal of improving the quality of the generated 3D scene. The modified text prompt 210 is used as the input to action agent 202 at the next time step of an episode or iteration of the process. At a given time step t or iteration, action agent 202 can guided by feedback 260 based on a reward signal.

At a time step t, text prompt 222 (e.g., T^{t}) is the input to action agent 202. Text prompt 222 is input into encoder 302 to obtain one or more token-level embeddings 310 representing text prompt 222. The one or more token-level embeddings 310 are input into policy network 304 to obtain modified text prompt 210.

Encoder 302 can include a transformer-based neural network, such as Bidirectional Encoder Representations from Transformers (BERT). A transformer-based neural network can understand the context of words more effectively and capture rich semantic information from text. The semantic and syntactic relationships extracted by encoder 302 can be helpful for modifying the text prompts downstream, enabling policy network 304 to produce meaningful modifications that can improve the alignment between text prompt 222 and the generated 3D scene. Encoder 302 produces one or more embeddings that represent text prompt 222:

$${f}^{t} = {\{ {f}_{i} \}}_{i = 1}^{N} \qquad ( eq . 12 )$$

{fᵢ}ᵢ₌₁^{N} includes N token-level embeddings extracted from text prompt 222 by encoder 302, where N is the number of tokens in text prompt 222. For the cold start condition, the initial input text prompt T⁰ is encoded by encoder 302 to obtain one or more embeddings f⁰.

The design of policy network 304 is not trivial. Policy network 304 (denoted Tte) is designed to explore a range of possible text modifications while balancing exploration and exploitation. In reinforcement learning, exploration refers to trying new modifications that may lead to better results, while exploitation focuses on refining prompts that have previously yielded high rewards. The balance helps to ensure that the system does not converge too quickly on a local optimum and instead continues to explore modifications to the text prompts that may improve the overall quality of the generated 3D scenes. The exploration can be modeled using a SoftMax distribution over the possible/candidate text modifications. policy network 304 can select the modified text prompt from candidate text modifications based on an expected reward for selecting the modified text prompt. In some implementations, the selection can be performed randomly from a set of candidate text modifications having the highest expected rewards to further encourage exploration and add noise to the selection process. Given the encoded representation f^{t-1} and the reward signal R^{t-1}, the probability of selecting a particular modification at time t can be given by:

$${π}_{θ} ( {a}_{c} \vert {f}^{t - 1} , {R}^{t - 1} ) = \frac{exp ( {Q}_{θ} ( {f}^{t - 1} , {a}_{t} ) )}{{\sum }_{{a}^{′} ∈ 𝒜} exp ( {Q}_{θ} ( {f}^{t - 1} , {a}^{′} ) )} \qquad ( eq . 13 )$$

Q_{θ}(f^{t-1}, αₜ) represents the expected reward for selecting modification at based on the encoded representation f^{t-1}, and [symbol] represents the set of possible/candidate text modifications (sometimes referred to as the action space). Equation 13 models a stochastic policy and allows policy network 304 to explore a variety of text modifications, ensuring that the system does not prematurely convert on a local maximum or a suboptimal solution.

Policy network 304 is optimized using feedback from the reward signal R^{t-1}, which is calculated by the reward agent after each 3D scene is generated. The reward signal R^{t-1} guides the modification of text prompts by policy network 304, helping the system learn which prompts lead to higher-quality 3D scenes. As policy network 304 is updated over time, policy network 304 can become increasingly proficient at generating prompts that result in better scene generation. Moreover, the one or more parameters θ of policy network 304 are updated to maximize the expected cumulative reward over one or more time steps in an episode ensuring that each text modification leads to better scene generation in subsequent time steps or iterations in the episode.

In some embodiments, policy network 304 includes a neural network, such as three fully connected layers, designed to balance efficiency and flexibility in modeling the relationships between text prompts and generated 3D scenes. The input to policy network 304 is the encoded representation f^{t-1} from the previous time step, and the output of policy network 304 can include a probability distribution over possible text modifications. Rectified Linear Unit (ReLU) activations can be used after each hidden layer, while the output layer can apply a SoftMax function to ensure a valid probability distribution. The design of policy network 304 allows generation agent 204 to stochastically explore text modifications while being updated based on reward feedback from generated 3D scenes.

Action agent 202 processes natural language text prompts and encodes them using encoder 302. Action agent 202 modifies the prompts using policy network 304 iteratively based on feedback from the reward agent. Action agent 202 can be initialized with an unmodified input text prompt T°, and subsequent modified text prompts are refined iteratively/successively/progressively using policy network 304 that balances exploration and exploitation to discover an optimal/optimum possible modification for generating high-quality 3D scenes.

### Implementing the Generation Agent

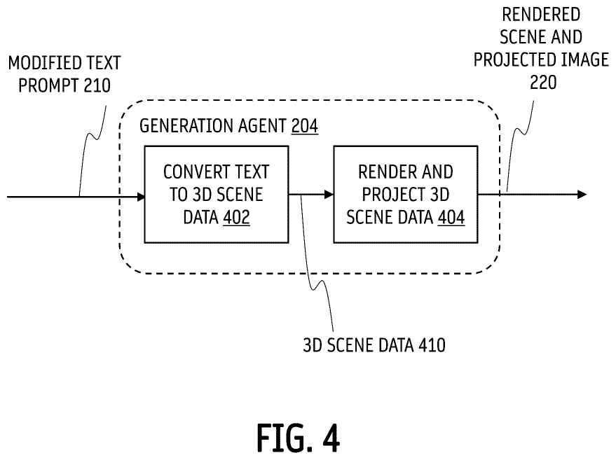

FIG. 4 illustrates an exemplary implementation of a generation agent, such as generation agent 204, according to some embodiments of the disclosure. Generation agent 204 is responsible for transforming modified text prompt 210 into rendered scene and projected image 220. Generation agent 204 plays a role in bridging the gap between the natural language description of a 3D scene in the input text prompt and the desired visual output of the 3D scene. The design of generation agent 204 is not trivial, and components are included and designed to effectively, scalably, and robustly handle the complexity of two tasks: (1) converting text descriptions into structured 3D scene data 402, and (2) rendering/projecting the structured 3D scene data 402 to produce rendered scene and projected image 220.

Generation agent 204 includes convert text to 3D scene data 402 and render and project 3D scene data 404. Convert text to 3D scene data 402 receives modified text prompt 210. Convert text to 3D scene data 402 converts modified text prompt 210 into 3D scene data 410. Render and project 3D scene data 404 can obtain a projected image based on 3D scene data 410. Render and project 3D scene data 404 can obtain a rendered image based on 3D scene data 410.

Given a modified text prompt T^{t}, convert text to 3D scene data 402 maps the natural language description into 3D scene data 410, which can include, e.g., a set of 3D position coordinates and characteristics/attributes/properties for one or more objects. The mapping can be formulated as:

$${C}^{t} = {f}_{ϕ} ( {T}^{t} ) \qquad ( eq . 14 )$$

C^{t} represents 3D scene data 410. f_{ϕ}(·) is a function parameterizable by ϕ and transforms the modified input text T^{t} into C^{t}.

Herein, 3D scene data 410 includes a structured description that can be produced or extracted from modified text prompt 210. 3D scene data 410 can include one or more three-dimensional coordinates representing one or more positions of one or more objects, and one or more object properties characterizing the one or more objects. The one or more object properties can be associated with one or more of: size, color, and texture. 3D scene data 410 can serve as intermediate representation of the 3D scene. In some cases, 3D scene data 410 may include a scene graph (e.g., hierarchical data structures that represent the spatial and logical relationships between objects in a scene, where each node in the graph represents an object, and edges represent relationships like parent-child or transformations). In some cases, 3D scene data 410 may include object-oriented models (e.g., each object is described by its properties such as shape, size, color, texture, relationships with other objects, and behaviors). In some cases, 3D scene data 410 may include semantic scene representation (e.g., each object is annotated with semantic labels and properties). In some cases, 3D scene data 410 may include a geometric model (e.g., using mathematical representations to describe the shapes and position of objects through polygonal meshes).

Convert text to 3D scene data 402 can include a transformer-based neural network (e.g., a large language model) trained to interpret complex, multi-object relationships, and spatial configurations described in natural language. The transformer-based neural network implementation can generalize effectively across diverse natural language descriptions and does not require the descriptions to follow a certain format. The transformer-based neural network implementation can perform well even when the natural language descriptions involve intricate spatial dependencies or nuanced semantics. The transformer-based neural network implementation can handle the variability and richness of human language. By leveraging a robust model that has been trained on a large corpus of natural language data, convert text to 3D scene data 402 is able to parse and generate semantically correct 3D scene data (or configurations). Convert text to 3D scene data 402 can understand and process ambiguous descriptions or prompts that involve nuanced object relationships.

Once modified text prompt 210 has been converted into 3D scene data 410, render and project scene data 404 renders 3D scene data 410 using a 3D rendering engine. In one example, Blender is used as the 3D rendering engine, which has capabilities in generating high-quality 3D scenes from complex 3D scene data 410, including physically-based rendering, complex object geometries, and realistic lighting. The rendering process can be formulated as:

$${S}^{t} = Render ( {C}^{t} ) \qquad ( eq . 14 )$$

S^{t} is the rendered scene at time step t. Render(·) represents the rendering process of the 3D rendering engine. Using a high-quality 3D rendering engine that can perform realistic rendering can positively impact the reward components relating to the perceived quality and accuracy of the generated scenes (which in turn impacts the feedback reinforcement learning loop).

Besides rendering 3D scene data 410, render and project 3D scene data 404 can output a 2D projection, i.e., a projected image I^{t}. The 2D projection is useful because the reward components involve 2D image-based metrics. The projection process performed by render and project 3D scene data 404 can be formulated as:

$${I}^{t} = Project ( {S}^{t} , view ) \qquad ( eq . 14 )$$

S^{t} is the rendered scene at time step t. Project (.) represents the 2D projection process, which captures a snapshot of the 3D scene from a fixed, predefined viewing pose/direction (as opposed to an arbitrary direction) to produce a 2D projected image I^{t}. The fixed, predefined viewing direction is represented by view. The 2D projected image I^{t} is used for evaluation and reward calculation because it simplifies the process of accessing the quality of the generated 3D scenes. SSIM score and FID score as discussed with the reward agent being used to assess the similarity between two images would be more consistent across different time steps (and episodes) when a fixed, predefined viewing pose/direction is used to allow a consistent and fair comparison between the two images or two scenes. Using 2D projected image I^{t} for evaluation and reward calculation can also reduce computational complexity, because evaluating 3D scenes and calculating metrics can be challenging to implement in practice.

Generation agent 204 is flexible and robust. Generation agent 204 can ensure that the system can generate a wide variety of 3D scenes that faithfully reflect the input text prompts while maintaining high visual quality. Generation agent 204 can efficiently and effectively convert modified text prompts into high-quality 3D scenes using a combination of natural language understanding and 3D rendering techniques.

### Methods and Algorithms for Training a Policy Network

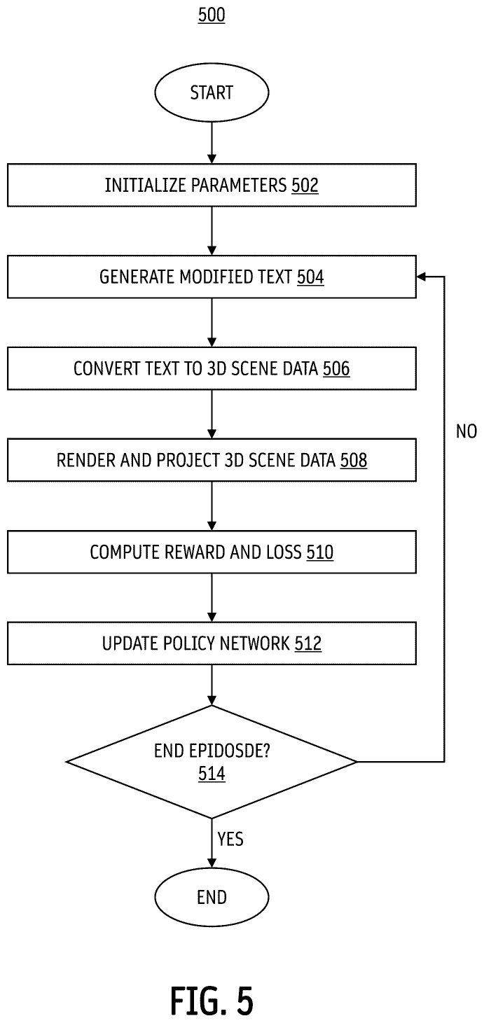

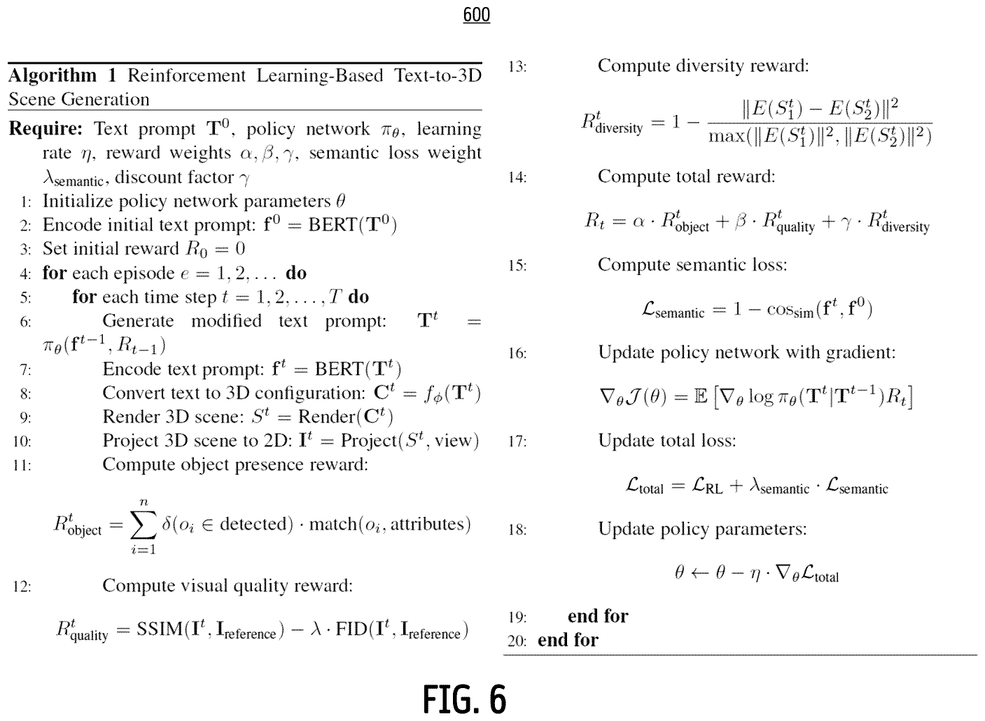

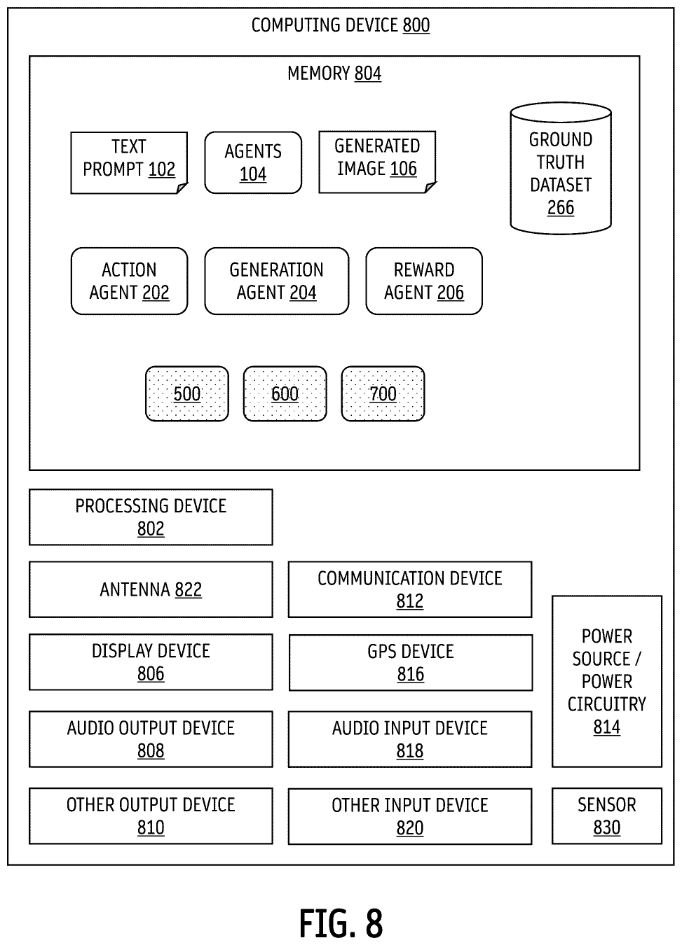

FIG. 5 is a flowchart illustrating a method for training a policy network, according to some embodiments of the disclosure. FIG. 6 illustrates algorithm 600 for training a policy network, capturing method 500 illustrated in FIG. 5, according to some embodiments of the disclosure. Method 500 can be implemented by one or more of: action agent 202, generation agent 204, and reward agent 206, as described herein. Method 500 can be performed using a computing device, such as computing device 800 in FIG. 8. BERT is used as the encoder for encoding text prompts as an illustration. It is understood that other encoders can be used.

In 502, one or more parameters of the algorithm are initialized. The operation is illustrated by lines 1-3 in FIG. 6.

Algorithm 600 illustrated in FIG. 6 has two loops. In a first loop, a number of episodes are performed/played. The first loop is illustrated by line 4 in FIG. 6. In a second loop within the first loop, a number of time steps up to the episode length are performed, e.g., until a condition is met to end an episode. The second loop is illustrated by line 5 in FIG. 6. In some implementations, the condition is checked in 514 whether to end an episode. The condition may include whether an SSIM score is greater than a certain threshold value (e.g., 0.89).

In 504, the modified text prompt is generated based on an input text prompt. The operation is illustrated by line 6 in FIG. 6. The operation can be performed by action agent 202 of FIGS. 2-3.

Line 7 in FIG. 6 obtains an embedded representation of the modified text prompt to be used later in the semantic loss calculation of line 15 in FIG. 6.

In 506, the modified text prompt is converted to 3D scene data. The operation is illustrated by line 8 in FIG. 6. The operation can be performed by generation agent 204 of FIGS. 2-4.

In 508, 3D scene data is rendered to obtain a rendered scene. The rendered scene is projected into a projected image. The rendering and projection operations are illustrated by lines 9-10 in FIG. 6 respectively. The operation can be performed by generation agent 204 of FIGS. 2-4.

In 510, the reward can be computed. The loss can be computed. The reward calculation operation is illustrated by lines 11-14 in FIG. 6. The loss calculation operation is illustrated by lines 15-17 in FIG. 6. The operation can be performed by reward agent 206 of FIG. 2.

In 512, one or more parameters of the policy network can be updated. The operation is illustrated by line 18 of FIG. 6. The operation can be performed by reward agent 206 of FIG. 2.

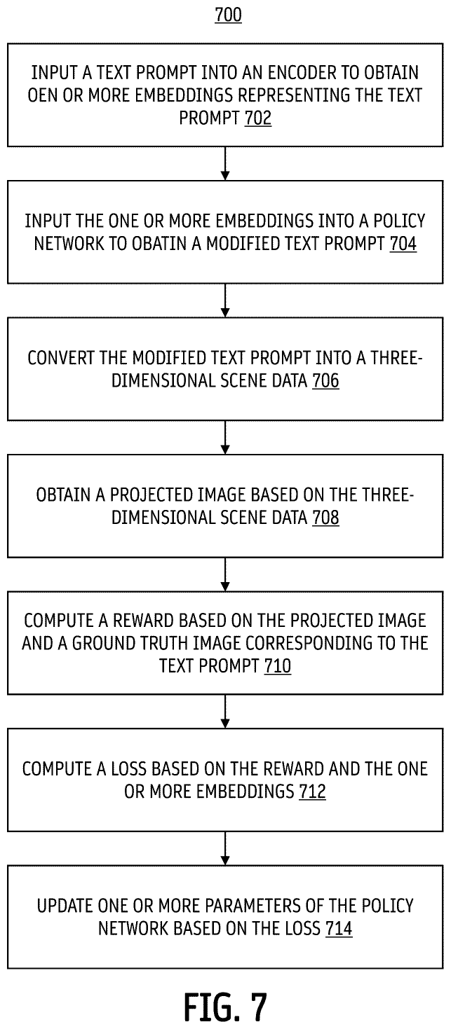

FIG. 7 is a flowchart illustrating a method for training a policy network, according to some embodiments of the disclosure. Method 700 can be implemented by one or more of: action agent 202, generation agent 204, and reward agent 206, as described herein. Method 700 can be performed using a computing device, such as computing device 800 in FIG. 8.

In 702, a text prompt is input into an encoder to obtain one or more embeddings representing the text prompt. The encoder can include a transformer-based neural network, or similar neural network that can understand the context of words in the text prompt and capture rich semantic information of words in the text prompt.

In 704, the one or more embeddings are input into a policy network to obtain a modified text prompt.

In 706, the modified text prompt is converted into a three-dimensional scene data.

In 708, a projected image is obtained based on the three-dimensional scene data.

In 710, a reward is computed based on the projected image and a ground truth image corresponding to the text prompt.

In 712, a loss is computed based on the reward and the one or more embeddings.

In 714, one or more parameters of the policy network are updated based on the loss.

### Exemplary Computing Device

FIG. 8 is a block diagram of an apparatus or a system, e.g., an exemplary computing device 800, according to some embodiments of the disclosure. One or more computing devices 800 may be used to implement the functionalities described with the FIGS. and herein. A number of components illustrated in FIG. 8 can be included in computing device 800, but any one or more of these components may be omitted or duplicated, as suitable for the application. In some embodiments, some or all of the components included in computing device 800 may be attached to one or more motherboards. In some embodiments, some or all of these components are fabricated onto a single system on a chip (SoC) die. Additionally, in various embodiments, computing device 800 may not include one or more of the components illustrated in FIG. 8, and computing device 800 may include interface circuitry for coupling to the one or more components. For example, the computing device 800 may not include display device 806, and may include display device interface circuitry (e.g., a connector and driver circuitry) to which a display device 806 may be coupled. In another set of examples, computing device 800 may not include audio input device 818 or an audio output device 808 and may include audio input or output device interface circuitry (e.g., connectors and supporting circuitry) to which an audio input device 818 or audio output device 808 may be coupled.

Computing device 800 may include processing device 802 (e.g., one or more processing devices, one or more of the same types of processing device, one or more of different types of processing device). Processing device 802 may include electronic circuitry that process electronic data from data storage elements (e.g., registers, memory, resistors, capacitors, quantum bit cells) to transform that electronic data into other electronic data that may be stored in registers and/or memory. Examples of processing device 802 may include a CPU, a GPU, a quantum processor, a machine learning processor, an artificial intelligence processor, a neural network processor, a neural processing unit (NPU), an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 804 includes one or more non-transitory computer-readable storage media. In some embodiments, memory 804 may include memory that shares a die with the processing device 802. Memory 804 may store machine-readable instructions, and processing device 802 may execute the machine-readable instructions.

In some embodiments, memory 804 includes one or more non-transitory computer-readable media storing instructions executable to perform operations described with the FIGS. and herein, such as the methods and operations illustrated in the FIGS. 1n some embodiments, memory 804 includes one or more non-transitory computer-readable media storing instructions executable to perform one or more operations illustrated in FIGS. 5-7. Exemplary parts that may be encoded as instructions and stored in memory 804 are depicted. Memory 804 may store instructions that encode one or more exemplary parts, such as one or more of: one or more agents 104, action agent 202, generation agent 204, and reward agent 206. The instructions stored in the one or more non-transitory computer-readable media may be executed by processing device 802.

In some embodiments, memory 804 may store data, e.g., data structures, binary data, bits, metadata, files, blobs, etc., as described with the FIGS. and herein. For example, memory 804 may include one or more of: text prompt 102, generated image 106, and ground truth dataset 266. Memory 804 may store data received and/or generated by parts such as one or more agents 104, action agent 202, generation agent 204, and reward agent 206.

In some embodiments, the computing device 800 may include a communication device 812 (e.g., one or more communication devices). For example, the communication device 812 may be configured for managing wired and/or wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 812 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 812 may operate in accordance with other wireless protocols in other embodiments. The computing device 800 may include an antenna 822 to facilitate wireless communications and/or to receive other wireless communications (such as radio frequency transmissions). The computing device 800 may include receiver circuits and/or transmitter circuits. In some embodiments, the communication device 812 may manage wired communications, such as electrical, optical, or any other suitable communication protocols (e.g., the Ethernet). As noted above, the communication device 812 may include multiple communication chips. For instance, a first communication device 812 may be dedicated to shorter-range wireless communications such as Wi-Fi or Bluetooth, and a second communication device 812 may be dedicated to longer-range wireless communications such as global positioning system (GPS), EDGE, GPRS, CDMA, WiMAX, LTE, EV-DO, or others. In some embodiments, a first communication device 812 may be dedicated to wireless communications, and a second communication device 812 may be dedicated to wired communications.

The computing device 800 may include power source/power circuitry 814. The power source/power circuitry 814 may include one or more energy storage devices (e.g., batteries or capacitors) and/or circuitry for coupling components of the computing device 800 to an energy source separate from the computing device 800 (e.g., DC power, AC power, etc.).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include a sensor 830 (or one or more sensors). The computing device 800 may include corresponding interface circuitry, as discussed above). Sensor 830 may sense physical phenomenon and translate the physical phenomenon into electrical signals that can be processed by, e.g., processing device 802. Examples of sensor 830 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 800 may include another output device 810 (or corresponding interface circuitry, as discussed above). Examples of the other output device 810 may include an audio codec, a video codec, a printer, a wired or wireless transmitter for providing information to other devices, haptic output device, gas output device, vibrational output device, lighting output device, home automation controller, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smart phone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 800 may be any other electronic device that processes data.

### Select Examples

Example 1 provides an apparatus including one or more memories storing machine-readable instructions; and one or more computer processors, when executing the machine-readable instructions, are to: input a text prompt into an encoder to obtain one or more embeddings representing the text prompt, the encoder including a transformer-based neural network; input the one or more embeddings into a policy network to obtain a modified text prompt; convert the modified text prompt into a three-dimensional scene data; obtain a projected image based on the three-dimensional scene data; compute a reward based on the projected image and a ground truth image corresponding to the text prompt; compute a loss based on the reward and the one or more embeddings; and update one or more parameters of the policy network based on the loss.

Example 2 provides the apparatus of example 1, where the policy network selects the modified text prompt from candidate text modifications based on an expected reward for selecting the modified text prompt.

Example 3 provides the apparatus of example 1 or 2, where the three-dimensional scene data includes one or more three-dimensional coordinates representing one or more positions of one or more objects, and one or more object properties characterizing the one or more objects.

Example 4 provides the apparatus of example 3, where the one or more object properties are associated with one or more of: size, color, and texture.

Example 5 provides the apparatus of any one of examples 1-4, where computing the reward includes computing the reward based on a weighted sum of one or more reward components, the one or more reward components including one or more of: an object presence reward component, a visual quality reward component, and a diversity reward component.

Example 6 provides the apparatus of any one of examples 1-5, where computing the reward includes computing an object presence reward component based on one or more of: whether an expected object is present in the projected image, and whether an attribute of an object present in the projected image matches an expected attribute of the expected object.

Example 7 provides the apparatus of any one of examples 1-6, where computing the reward includes computing a visual quality reward component based on one or more of: a similarity score between the projected image and the ground truth image, and a distance score between the projected image and the ground truth image.

Example 8 provides the apparatus of any one of examples 1-7, where: the one or more computer processors are further to obtain a rendered scene based on the three-dimensional scene data; where computing the reward includes computing a diversity reward component that is a contrastive loss score between a rendered scene and a further rendered scene generated based on a further text prompt.

Example 9 provides the apparatus of any one of examples 1-8, where computing the loss includes computing the loss based on a weighted sum of one or more loss components, the one or more loss components including one or more of: a reinforcement learning loss and a semantic loss.

Example 10 provides the apparatus of example 9, where the reinforcement learning loss is based on the reward.

Example 11 provides the apparatus of example 9 or 10, where the semantic loss is based on the one or more embeddings and one or more further embeddings representing the modified text prompt.

Example 12 provides one or more non-transitory computer-readable media storing instructions executable by a processor to perform operations, the operations including inputting a text prompt into an encoder to obtain one or more embeddings representing the text prompt, the encoder including a transformer-based neural network; inputting the one or more embeddings into a policy network to obtain a modified text prompt; converting the modified text prompt into a three-dimensional scene data; obtaining a projected image based on the three-dimensional scene data; computing a reward based on the projected image and a ground truth image corresponding to the text prompt; computing a loss based on the reward and the one or more embeddings; and updating one or more parameters of the policy network based on the loss.

Example 13 provides the one or more non-transitory computer-readable media of example 12, where the policy network selects the modified text prompt from candidate text modifications based on an expected reward for selecting the modified text prompt.

Example 14 provides the one or more non-transitory computer-readable media of example 12 or 13, where the three-dimensional scene data includes one or more three-dimensional coordinates representing one or more positions of one or more objects, and one or more object properties characterizing the one or more objects.

Example 15 provides the one or more non-transitory computer-readable media of example 14, where the one or more object properties are associated with one or more of: size, color, and texture.

Example 16 provides the one or more non-transitory computer-readable media of any one of examples 12-15, where computing the reward includes computing the reward based on a weighted sum of one or more reward components, the one or more reward components including one or more of: an object presence reward component, a visual quality reward component, and a diversity reward component.

Example 17 provides the one or more non-transitory computer-readable media of any one of examples 12-16, where computing the reward includes computing an object presence reward component based on one or more of: whether an expected object is present in the projected image, and whether an attribute of an object present in the projected image matches an expected attribute of the expected object.

Example 18 provides the one or more non-transitory computer-readable media of any one of examples 12-17, where computing the reward includes computing a visual quality reward component based on one or more of: a similarity score between the projected image and the ground truth image, and a distance score between the projected image and the ground truth image.

Example 19 provides the one or more non-transitory computer-readable media of any one of examples 12-18, where: the operations further include obtaining a rendered scene based on the three-dimensional scene data; where computing the reward includes computing a diversity reward component that is a contrastive loss score between a rendered scene and a further rendered scene generated based on a further text prompt.

Example 20 provides the one or more non-transitory computer-readable media of any one of examples 12-19, where computing the loss includes computing the loss based on a weighted sum of one or more loss components, the one or more loss components including one or more of: a reinforcement learning loss and a semantic loss.

Example 21 provides the one or more non-transitory computer-readable media of example 20, where the reinforcement learning loss is based on the reward.

Example 22 provides the one or more non-transitory computer-readable media of example 20 or 21, where the semantic loss is based on the one or more embeddings and one or more further embeddings representing the modified text prompt.

Example 23 provides a method, including inputting a text prompt into an encoder to obtain one or more embeddings representing the text prompt, the encoder including a transformer-based neural network; inputting the one or more embeddings into a policy network to obtain a modified text prompt; converting the modified text prompt into a three-dimensional scene data; obtaining a projected image based on the three-dimensional scene data; computing a reward based on the projected image and a ground truth image corresponding to the text prompt; computing a loss based on the reward and the one or more embeddings; and updating one or more parameters of the policy network based on the loss.

Example 24 provides the method of example 23, where the policy network selects the modified text prompt from candidate text modifications based on an expected reward for selecting the modified text prompt.

Example 25 provides the method of example 23 or 24, where the three-dimensional scene data includes one or more three-dimensional coordinates representing one or more positions of one or more objects, and one or more object properties characterizing the one or more objects.

Example 26 provides the method of example 25, where the one or more object properties are associated with one or more of: size, color, and texture.

Example 27 provides the method of any one of examples 23-26, where computing the reward includes computing the reward based on a weighted sum of one or more reward components, the one or more reward components including one or more of: an object presence reward component, a visual quality reward component, and a diversity reward component.

Example 28 provides the method of any one of examples 23-27, where computing the reward includes computing an object presence reward component based on one or more of: whether an expected object is present in the projected image, and whether an attribute of an object present in the projected image matches an expected attribute of the expected object.

Example 29 provides the method of any one of examples 23-28, where computing the reward includes computing a visual quality reward component based on one or more of: a similarity score between the projected image and the ground truth image, and a distance score between the projected image and the ground truth image.

Example 30 provides the method of any one of examples 23-29, further including obtaining a rendered scene based on the three-dimensional scene data; where computing the reward includes computing a diversity reward component that is a contrastive loss score between a rendered scene and a further rendered scene generated based on a further text prompt.

Example 31 provides the method of any one of examples 23-30, where computing the loss includes computing the loss based on a weighted sum of one or more loss components, the one or more loss components including one or more of: a reinforcement learning loss and a semantic loss.

Example 32 provides the method of example 31, where the reinforcement learning loss is based on the reward.

Example 33 provides the method of example 31 or 32, where the semantic loss is based on the one or more embeddings and one or more further embeddings representing the modified text prompt.

Example 34 provides an apparatus including means to perform a method according to any one of examples 23-33.

Example 35 provides a computer program product including instructions which, when executed by a processor, cause the processor to perform a method according to any one of examples 23-33.

Example 36 provides machine-readable storage including machine-readable instructions, when executed, cause a computer to implement a method according to any one of examples 23-33.

Example 37 provides a computer program including instructions which, when the computer program is executed by a processing device, cause the processing device to carry out a method according to any one of examples 23-33.

Example 38 provides one or more agents as illustrated by FIG. 1.

Example 39 provides one or more agents as illustrated by FIG. 2.

Example 40 provides an action agent as illustrated by FIG. 3.

Example 41 provides a generation agent as illustrated by FIG. 4.

Example 42 provides a reward agent as illustrated by FIG. 2.

Example 44 provides a system including one or more of an action agent, a generation agent, and a reward agent as illustrated by FIG. 2.

Example 45 provides a computer program product including instructions which, when executed by a processor, cause the processor to perform method 500 of FIG. 5 and/or algorithm illustrated in FIG. 6.

Example 46 provides machine-readable storage including machine-readable instructions, when executed, cause a computer to implement a method according to method 500 of FIG. 5 and/or algorithm illustrated in FIG. 6.

Example 47 provides a computer program including instructions which, when the computer program is executed by a processing device, cause the processing device to carry out method 500 of FIG. 5 and/or algorithm illustrated in FIG. 6.

### Variations and Other Notes

Although the operations of the example method shown in and described with reference to FIGS. are illustrated as occurring once each and in a particular order, it will be recognized that the operations may be performed in any suitable order and repeated as desired. Additionally, one or more operations may be performed in parallel. Furthermore, the operations illustrated in FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. I^{t} is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus comprising:
one or more memories storing machine-readable instructions; and
one or more computer processors, when executing the machine-readable instructions, are to:
input a text prompt into an encoder to obtain one or more embeddings representing the text prompt, the encoder including a transformer-based neural network;
input the one or more embeddings into a policy network to obtain a modified text prompt;
convert the modified text prompt into a three-dimensional scene data;
obtain a projected image based on the three-dimensional scene data;
compute a reward based on the projected image and a ground truth image corresponding to the text prompt;
compute a loss based on the reward and the one or more embeddings; and
update one or more parameters of the policy network based on the loss.

2. The apparatus of claim 1, wherein the policy network selects the modified text prompt from candidate text modifications based on an expected reward for selecting the modified text prompt.

3. The apparatus of claim 1, wherein the three-dimensional scene data comprises one or more three-dimensional coordinates representing one or more positions of one or more objects, and one or more object properties characterizing the one or more objects.

4. The apparatus of claim 3, wherein the one or more object properties are associated with one or more of: size, color, and texture.

5. The apparatus of claim 1, wherein computing the reward comprises:
computing the reward based on a weighted sum of one or more reward components, the one or more reward components including one or more of: an object presence reward component, a visual quality reward component, and a diversity reward component.

6. The apparatus of claim 1, wherein computing the reward comprises:
computing an object presence reward component based on one or more of: whether an expected object is present in the projected image, and whether an attribute of an object present in the projected image matches an expected attribute of the expected object.

7. The apparatus of claim 1, wherein computing the reward comprises:
computing a visual quality reward component based on one or more of: a similarity score between the projected image and the ground truth image, and a distance score between the projected image and the ground truth image.

8. The apparatus of claim 1, wherein:
the one or more computer processors are further to obtain a rendered scene based on the three-dimensional scene data;
wherein computing the reward comprises computing a diversity reward component that is a contrastive loss score between the rendered scene and a further rendered scene generated based on a further text prompt.

9. The apparatus of claim 1, wherein computing the loss comprises:
computing the loss based on a weighted sum of one or more loss components, the one or more loss components including one or more of: a reinforcement learning loss and a semantic loss.

10. The apparatus of claim 9, wherein the reinforcement learning loss is based on the reward.

11. The apparatus of claim 9, wherein the semantic loss is based on the one or more embeddings and one or more further embeddings representing the modified text prompt.

12. One or more non-transitory computer-readable media storing instructions executable by a processor to perform operations, the operations comprising:
inputting a text prompt into an encoder to obtain one or more embeddings representing the text prompt, the encoder including a transformer-based neural network;
inputting the one or more embeddings into a policy network to obtain a modified text prompt;
converting the modified text prompt into a three-dimensional scene data;
obtaining a projected image based on the three-dimensional scene data;
computing a reward based on the projected image and a ground truth image corresponding to the text prompt;
computing a loss based on the reward and the one or more embeddings; and
updating one or more parameters of the policy network based on the loss.

13. The one or more non-transitory computer-readable media of claim 12, wherein the policy network selects the modified text prompt from candidate text modifications based on an expected reward for selecting the modified text prompt.

14. The one or more non-transitory computer-readable media of claim 12, wherein computing the reward comprises:
computing the reward based on a weighted sum of one or more reward components, the one or more reward components including one or more of: an object presence reward component, a visual quality reward component, and a diversity reward component.

15. The one or more non-transitory computer-readable media of claim 12, wherein computing the reward comprises:
computing an object presence reward component based on one or more of: whether an expected object is present in the projected image, and whether an attribute of an object present in the projected image matches an expected attribute of the expected object.

16. The one or more non-transitory computer-readable media of claim 12, wherein computing the reward comprises:
computing a visual quality reward component based on one or more of: a similarity score between the projected image and the ground truth image, and a distance score between the projected image and the ground truth image.

17. The one or more non-transitory computer-readable media of claim 12, wherein:
the operations further include obtaining a rendered scene based on the three-dimensional scene data;
wherein computing the reward comprises computing a diversity reward component that is a contrastive loss score between the rendered scene and a further rendered scene generated based on a further text prompt.

18. A method, comprising:
inputting a text prompt into an encoder to obtain one or more embeddings representing the text prompt, the encoder including a transformer-based neural network;
inputting the one or more embeddings into a policy network to obtain a modified text prompt;
converting the modified text prompt into a three-dimensional scene data;
obtaining a projected image based on the three-dimensional scene data;
computing a reward based on the projected image and a ground truth image corresponding to the text prompt;
computing a loss based on the reward and the one or more embeddings; and
updating one or more parameters of the policy network based on the loss.

19. The method of claim 18, wherein:
computing the loss based on a weighted sum of one or more loss components; and
the one or more loss components comprise a reinforcement learning loss based on the reward.

20. The method of claim 19, wherein:
computing the loss based on a weighted sum of one or more loss components; and
the one or more loss components comprise a semantic loss based on the one or more embeddings and one or more further embeddings representing the modified text prompt.
